(19) United States
(12) Patent Application Publication
(10) Pub. No.: US 2021/0057965 A1
(43) Pub. Date: Feb. 25, 2021

(54) NOISE REDUCTION FOR DIRECT CURRENT EXCITED BRUSHED ASYMMETRIC MOTOR

(71) Applicant: NIDEC Motors & Actuators (Germany) GmbH, Bietigheim-Bissingen (DE)

(72) Inventors: Niklas HERMANN, Bad Wildbad (DE); Rainer BRUHN, Ingersheim (DE); Christian SIELER, Ingersheim (DE); Maria GAREIS, Heilbronn (DE); Tanja SIELER, Ingersheim (DE); Max SCHWING, Ludwigsburg (DE)

(21) Appl. No.: 16/998,276

(22) Filed: Aug. 20, 2020

(30) Foreign Application Priority Data
Aug. 20, 2019 (DE) 10 2019 122 346.6

(51) Int. Cl. H02K 11/02; H02K 23/04; H02K 23/26; H02K 1/17; H02K 1/26

(52) U.S. Cl. CPC H02K 11/02; H02K 23/04; H02K 2213/03; H02K 1/17; H02K 1/265; H02K 23/26

(57) ABSTRACT

An asymmetrical, direct current excited brushed motor may include a motor shaft; a commutator with a number of lamellae arranged in the circumferential direction; an armature with a number of armature teeth and armature grooves, where anchor windings are arranged in the armature grooves to form coils; at least one brush pair for supplying the coils with power, including two brushes contacting the lamellae; and a number n of permanent magnets in the stator to form a magnetic field, where n is a multiple of 2 and n>2, and where the number of armature teeth is unequal to a multiple of n. A position angle between the brushes of a brush pair is equal to or less than 90° and unequal to a multiple of the position angle between two directly consecutive lamellae.

The present invention relates to a direct current excited, asymmetric brushed motor with the features of the preamble of claim 1.

In commutator motors, the current is supplied from the power supply or the control device via brushes which abut against the commutator divided into a plurality of lamellae and used for commutation. The lamellae are isolated from one another on the circumference of the commutator and are accordingly powered successively via the brushes when the rotor formed by the armature windings, motor shaft and commutator rotates. In doing so, each brush moves from one lamella to the next in the isolated intermediate area or the slot between two lamellae, wherein it simultaneously creates a contact between and short-circuits or bypasses the two adjacent lamellae, leading to a change in the current signal. The slot frequency is defined by the number of lamellae and switching states.

It is known that asymmetrical four-pole DC motors with two brushes with a position angle of 90° can be used. The term “asymmetric motor” is understood to mean that the number of lamellae corresponding to the number of anchor teeth is not equal to a whole multiple of the number of poles of the stator. In this embodiment, in the circumferential direction opposing lamellae are connected to one another and the corresponding coils are short-circuited, whereby only two brushes are required. The carbon brushes never have the same lamella overlap at the same time, i.e. the ratio of position angle between two brushes of a brush pair is not equal to a multiple (integer) of the position angle between two lamellae immediately consecutive in the circumferential direction. With two brushes there is then, by way of example, the coil state in which a first brush overlaps a single lamella, while a second brush contacts two lamellae, i.e. the two brushes rest simultaneously on different numbers of lamellae. During armature rotation this can lead both to an even and an odd number of commutated lamellae. Traditionally, medium or low impedance conditions occur with small resistors in the circuit resulting in high current peaks. These are undesirable because they cause noise.

The object of the present invention is to specify a direct current excited asymmetric brushed motor, having a noise reduction, with no perceptible adverse effect on motor performance.

This object is achieved by a direct current excited, asymmetric brushed motor with the features of claim 1. Advantageous further developments of the invention are mentioned in the dependent claims.

Accordingly, a DC excited brushed motor has:
a motor shaft,
a commutator with a number of lamellae arranged in the circumferential direction, having the same lamella angle, wherein the slot width is the same between two consecutive lamellae in the circumferential direction,
an armature with a number of armature teeth and armature grooves corresponding to the number of lamellae, wherein armature windings are arranged in the armature grooves to form coils,
at least one pair of brushes having two brushes on the lamellae to supply the coils with power,
a number of permanent magnets in the stator to form a magnetic field which is a (integer) multiple of 2 and greater than 2 (4,6,8, etc.), wherein the coils and commutator are mounted on the motor shaft as a rotatable rotor, and wherein the number of anchor teeth is not equal to a (integer) multiple of the number of permanent magnets (asymmetric motor).

The position angle between the two brushes of a brush pair is less than or equal to 90° and not equal to a (integer) multiple of the position angle between two lamellae immediately consecutive in the circumferential direction, wherein a lamella width, a slot width and a brush width are selected such that with a complete rotation of the rotor only first and second coil states occur, wherein a first coil state is present if one of the two brushes of the at least one brush pair commutates two adjacent lamellae and the other brushes of the at least one brush pair are contacting a single lamella and a second coil state is present if both brushes of the at least one brush pair in each case are contacting a single lamella and wherein a complete rotation of the rotor results in a maximum of 90% of the first coil state and the second coil state is present at least 10% of the time so that there is a division ratio of at least 9:1.

The two coil states that can be adopted, have a reduced ripple so that the motor is significantly quieter in operation. The division ratio is preferably at least 8:2. It is generally the case that the more second coil states there are in relation to the first coil states, the less noise there will be produced.

The brushes preferably have the same brush width. However, it is also conceivable that the brush width of the brushes of a brush pair is different, which, however, leads to a much greater design effort and causes higher costs.

The motor can, by way of example, be a four-pole motor comprising a combination of two, two-pole motors. This can comprise four brushes, arranged symmetrically every 90°. Where there are multiple brush pairs these are preferably axially symmetrically mirrored, i.e. for four brushes opposing brushes are provided with the same polarity and have the same lamella overlap. However, it may be that only two brushes are used if the armature coils are in each case short-circuited with the opposing armature coils. Three pairs of brushes can be used for a six-pole motor, and so on. The descriptive motor can be scaled as required.

In a preferred embodiment, a single brush pair is provided with two brushes, arranged at an orientation angle of 90° to one another on the commutator. It is preferable in this connection, that the first coil state is present when one of the two brushes short circuits two adjacent lamellae and the second brush contacts a single lamella and the second coil state is present when both brushes in each case contact a single lamella. At no point in time is a coil state adopted in which a total of four lamellae are short-circuited. The magnetic field is preferably four-pole.

The division ratio (T) is preferably generally given by

$$T = \frac{{T}_{3}}{1 - {T}_{3}} ,$$

wherein T₃ is the overlap ratio for the first coil state and is given by

$${T}_{3} = \frac{36 {0}^{∘} - 20 * ( a - b )}{36 {0}^{∘}} ,$$

wherein

$$a = \frac{β}{2} + γ - \frac{δ}{2} , is b = \frac{δ}{2} - \frac{γ}{2} ,$$

and b<a, wherein β is the lamella angle, γ is the slot angle and δ is the brush angle.

The motor is preferably dimensioned such that it has a lamella width in a range of between 2.5 mm and 10 mm, a slot width between the lamellae in a range of between 0.2 mm and 0.8 mm and/or a width of the brushes in a range of between 1.5 mm and 4 mm.

In an advantageous embodiment the motor is an internal rotor motor, whose rotor formed by the coils, the commutator and the motor shaft, is arranged inside the magnetic poles. The number of lamellae is preferably ten and the number of brush pairs one.

An adjustment system for a sliding roof of a motor vehicle is also provided for, wherein the adjustment system has a direct current excited, brushed motor with asymmetric division described above.

Preferred embodiments of the invention are explained in more detail below on the basis of the drawings. Similar or equivalent components are denoted by the same reference numerals in the figures. The following drawings show the following:

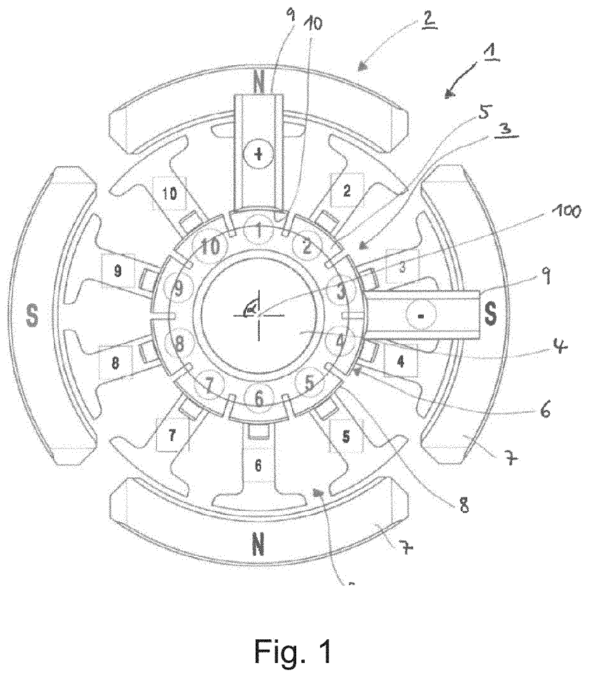

FIG. 1: a schematic diagram of a DC-excited brushed asymmetric motor,

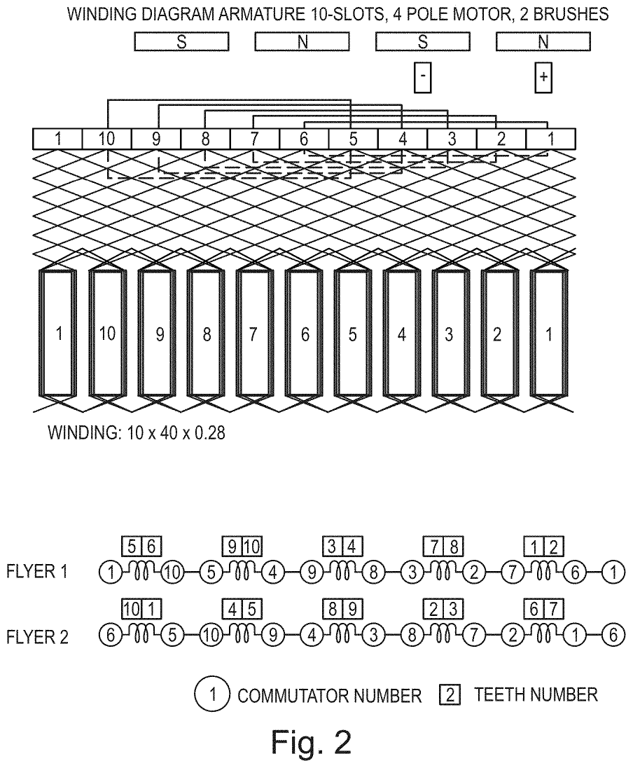

FIG. 2: a winding diagram of the motor from FIG. 1,

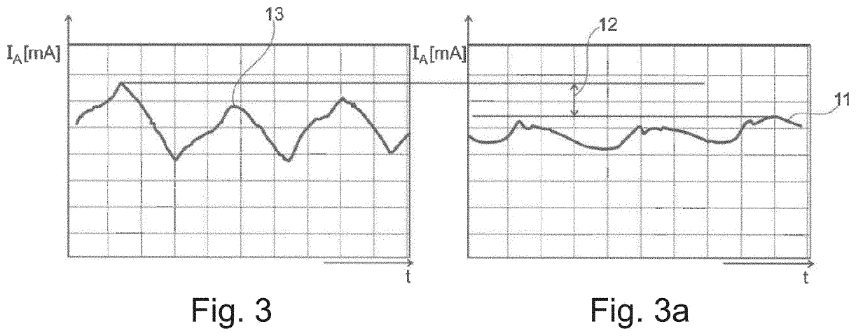

FIG. 3: a diagram of an armature current plotted against time with average and strong commutation,

FIG. 3a: a diagram of an armature current plotted against time with average and weak commutation,

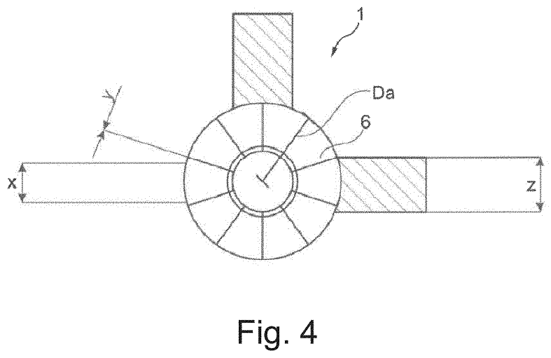

FIG. 4: a schematic representation of a direct current excited brushed motor, and

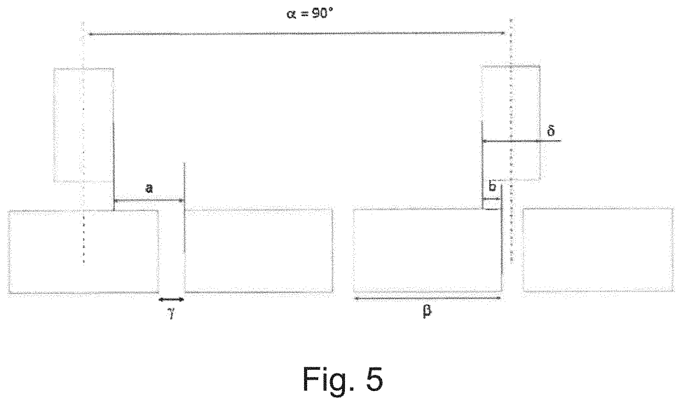

FIG. 5: a schematic representation of the geometry of the motor for the description of a switching ratio.

FIG. 1 shows an electric motor 1 with a stator 2 and a rotor 3, wherein the rotor 3 has a motor shaft 4, an armature with armature teeth and armature slots carrying armature windings for forming coils 5 and a commutator 6 and rotates about an axis of rotation 100. The stator 2 comprises two pairs of poles and a pole pot (not shown) forming four permanently excited stator poles 7. An internal rotor motor is present. On the commutator 6 of the four-pole motor 1, ten equally shaped lamellae 8 are arranged uniformly distributed in the circumferential direction. Two brushes 9 rest on the lamellae 8 arranged at an orientation angle α of 90° to the axis of rotation. The two brushes 9 form a brush pair. The winding diagram of the electric motor can be found in FIG. 2. Two layers are provided. In circumferential direction each two successive armature teeth (numbers shown in square boxes) are wrapped one after the other and connected to the lamellae shown in circles. The second layer has an offset of one armature tooth. Lamellae opposite each other in the circumferential direction are also connected to one another, such that the electric motor combines two motors which generate a common torque. A direct voltage is applied to the two brushes 9 by a control device (not shown), e.g. as a PWM signal, such that a current I results. The lamella-brush system therefore serves in a known manner as a mechanical commutation of the commutator motor 1. The lamellae 8 are arranged uniformly over the circumference of the commutator 6, wherein the brushes 9 slide on the rotor during rotational movement. Therefore each brush 9 periodically arrives at a slot 8a or isolated intermediate area between two lamellae 8. The brushes 9 are designed with a contact surface 10, which is greater than a slot 8a, so that the brushes 9 can briefly short circuit adjacent lamellae 8. The transition of the brushes 9 between adjacent lamellae 8 results in the formation of current ripples with a slot frequency. Motor 1 has an asymmetrical overlap of the lamellae by the brushes (unequal commutator overlap). In the switching state shown in FIG. 1 the first brush 9 overlaps a single lamella 8 while simultaneously the second brush 9 short circuits two lamellae 8. This represents what is known as an average coil state; two coils 5 are short circuited and the remaining coils 5 are uniformly powered, wherein the current level for each of these coils 5 is 1.

Irrespective of the number of slots, such direct current excited, asymmetric brushed motors have a total of three different coil states: weak, average and strong. This can be identified by the total resistance in the armature and the resulting current ripple. Depending on the state that the motor is in at the time, the coils 5 present will be powered at different strengths. This ensures magnetic forces of different strengths, meaning that in turn repulsions of different strengths between the armature and permanent magnet/stator result. These repulsions generate vibration noise, which affect the slot frequency, and its multiple.

In the strong coil state (low ohmic resistance) the four lamellae 8 are contacted and accordingly four coils 5 are short circuited. Four further coils 5 are simultaneously powered with a current level of 1 and the other two coils 5 are powered more strongly with a current level of 2. The more strongly powered coils 5 generate a high current ripple.

The weak coil state (high ohmic resistance) arises as a transition state during a rotation, when the brushes have a narrow contact surface with respect to the lamellae width. In this state only two lamellae 8 are contacted and therefore four coils 5 are uniformly powered with a current level of 1. Six further coils 5 are powered more weakly with a current level in each case of ⅔.

It is generally the case that the more weakly powered coils 5 generate a lower current ripple. Since the current ripple of the strong coil state is twice as high as that of the average coil state, this should be avoided in order to achieve a noise reduction. The current ripple of the weak state is ⅓ weaker than the average state.

A brushed DC motor must pass through at least two coil states during rotation, wherein the standard state of average is always generated. The strong and weak coil states can be selected by geometric adaptation of the lamella width, the slot width and the brush width. For an optimisation of the slot frequency in relation to a reduction in noise, the invention provides that the motor must remain for as long as possible in the weak coil state and should never assume the strong state

[symbol]

Irrespective of the current coil state, the total power in the armature remains the same. Therefore, a DC motor can generate a desired torque and the vibration noise of the slot frequency can nevertheless be reduced.

FIG. 3 shows the progression over time of an armature current I_{A} of a direct current excited asymmetric brushed motor with average and strong coil states. In comparison, FIG. 3a shows the progression over time of an armature current I_{A} of a direct current excited asymmetric brushed motor with average and weak coil states.

The current signal for average and weak coil states 11 has a significantly smaller amplitude. The arrow 12 indicates the difference between the maxima of the two curves. The area under the curve for average and weak coil states is therefore significantly smaller than the area under the curve of the current signal of the average and strong coil states 13. The area under the curve represents the respective power of the coil states, e.g. for the average and weak coil states the magnetisation of the individual coils is significantly smoother, the response impacts on the stator are reduced and the vibration noises of the slot frequency are reduced. The area under the curve is made up of a string of coil states. In the progression over time of the change between average and weak coil states 11 a current drop manifests itself after an armature current maximum. This drop is the result of the brush overcoming a commutator slot and reaching a new lamella. In this state vibrations on the carbon brush can lead to this “jumping” and for a very brief moment touching the commutator only partially (false, weak state although this would really still be the average state) or not at all. In the example of FIG. 1 a complete change from one lamella to the next, amounts to a rotation of the rotors about the axis of rotation of 36°. For each lamella change the motor switches four coil states.

FIGS. 4 and 5 show schematic representations of a direct current excited, brushed motor for the definition of a division ratio of the coil states or the commutation, also referred to as commutation ratio. The commutator 6 has a diameter in the region of the running surfaces (commutator external diameter) of Dₐ. The motor 1 has a lamella width x in the circumferential direction to the axis of rotation of the rotor on the running surface, corresponding to a lamella angle β

$$( β = \frac{b}{π} * \frac{{360}^{∘}}{{D}_{a}} ) .$$

Between each two lamellae a slot width y is provided, corresponding to a slot angle γ

$$( γ = \frac{36 {0}^{∘}}{π} * {sin}^{- 1} \frac{y}{{D}_{a}} ) .$$

The brushes have a width z in the circumferential direction to the axis of rotation of the rotor on the running surface, corresponding to a brush angle δ

$$( δ = \frac{36 {0}^{∘}}{π} * {sin}^{- 1} \frac{z}{{D}_{a}} ) .$$

Two brushes form an orientation angle α along the circumference to the axis of rotation.

According to the invention, the components of the motor are dimensioned such that the strong coil state is never achieved.

The division ratio T of the coil states average to weak is given for asymmetrical commutation and two brushes with α=90° by the following relations:

$$T = \frac{{T}_{3}}{1 - {T}_{3}} ,$$

wherein T₃ is the overlap ratio for the overlapping with three lamellae (average state) and is given by

$${T}_{3} = \frac{36 {0}^{∘} - 20 * ( a - b )}{36 {0}^{∘}}$$

wherein

$$a = \frac{β}{2} + γ - \frac{δ}{2} , is b = \frac{δ}{2} - \frac{γ}{2} .$$

Here, b<a, so that exclusively two or three lamellae are overlapped by the brushes. An overlapping of four lamellae is excluded here.

The time division ratio T of the coil states average to weak is preferably at least 9:1 for one full revolution of the rotor, i.e. the motor is in the average state in at most 90% of the armature rotation, and in the weak state in at least 10% of the armature rotation. The division ratio of 9:1 thus relates indirectly to the time during which one state is in use in relation to the other. The strong coil state is not present.

Here it is particularly preferable if a plurality of the four coil states switched per lamella change are weak and the proportion of weak coil states is high. Disruptive noises can thus be minimised.

The motor is preferably dimensioned such that x is in a range of between 2.5 mm and 10 mm, y in a range between 0.2 mm and 0.8 mm and z in a range of between 1.5 mm and 4 mm.

Through the adaptation described above of the commutator overlap by suitable selection of the carbon brush width, a noise reduction of the slot frequency can be achieved while obtaining constant stability of the brush system. The commutation of an asymmetric motor is optimised from 3 commutation to ⅔ commutation in order to achieve a better coil switching. The adjustment is therefore effected in the finest range.

1. ADC excited brushed motor having:
a motor shaft,
a commutator having a number of lamellae arranged in the circumferential direction, having the same lamella angle, wherein a common slot width is provided between two lamellae consecutive in a circumferential direction,
an armature with a number of armature teeth and armature grooves corresponding to the number of lamellae, with armature windings arranged in the armature grooves to form coils,
at least one pair of brushes having two brushes touching the lamellae for supplying the coils with power, and
a number n of permanent magnets in the stator for the formation of a magnetic field, wherein n is an integer multiple of 2 and n is greater than 2,
wherein the coils and the commutator are mounted on the motor shaft as a rotatable rotor,
wherein the number of anchor teeth is unequal to an integer multiple of the number n of permanent magnets,
wherein a position angle between the two brushes of a brush pair is less than or equal to 90° and unequal to an integer multiple of a position angle between two lamellae immediately consecutive in the circumferential direction,
wherein a lamella width, a slot width and a brush width are selected such that in a complete rotation of the rotor exclusively first and second coil states occur, wherein a first coil state is present when one of the two brushes of the at least one pair of brushes short-circuits two adjacent lamellae and the other brush of the at least one pair of brushes contacts a single lamella and a second coil state is present when both brushes of the at least one pair of brushes each contact a single lamella, and wherein in a complete rotation of the rotor at most 80% of the time first coil states and at least 20% of the time second coil states are present so that a time division ratio of at least 8:2 is present.

2. The direct current excited brushed motor according to claim 1, wherein the ting division ratio is at least 9:1.

3. The direct current excited brushed motor according to claim 1, wherein, in the circumferential direction, opposing lamellae are connected to one another.

4. The direct current excited brushed motor according to claim 1, wherein the motor has a single brush pair with two brushes arranged on the commutator at a position angle of 90° to one another.

5. The direct current excited brushed motor according to claim 4, wherein the first coil states are present if one of the two brushes short-circuits two adjacent lamellae and the second brush rests on a single lamella, and the second coil states are present if both brushes are in contact with a single lamella in each case.

6. The direct current excited brushed motor according to claim 1, wherein L magnetic field of the stator is four-pole.

7. The direct current excited brushed motor according to claim 1, wherein the time division ratio is given by
$$T = \frac{{T}_{3}}{1 - {T}_{3}}$$
wherein T₃ is an overlap ratio for the first coil state and is given by
$${T}_{3} = \frac{36 {0}^{∘} - 20 * ( a - b )}{36 {0}^{∘}} ,$$
wherein
$$a = \frac{β}{2} + γ - \frac{δ}{2} , b = \frac{δ}{2} - \frac{γ}{2} ,$$
b<a, and β is a lamella angle, γ is a slot angle and δ is a brush angle.

8. The direct current excited brushed motor according to claim 1, wherein a width of a lamella is in a range of between 2.5 mm and 10 mm, a slot width between two lamellae is in a range of between 0.2 mm and 0.8 mm and/or a width of the brush is in a range of between 1.5 mm and 4 mm.

9. The direct current excited brushed motor according to claim 1, wherein the motor is an internal rotor motor, whose rotor formed from the armature, commutator and motor shaft is arranged within magnetic poles.

10. The direct current excited brushed motor according to claim 1, wherein the number of lamellae is ten.

11. An adjustment system for a sunroof of a motor vehicle, wherein the adjustment system includes the direct current excited brushed motor according to claim 1.
